(19) United States
(12) Patent Application Publication
(10) Pub. No.: US 2025/0236078 A1
(43) Pub. Date: Jul. 24, 2025

(54) Method of manufacturing square tube from composite materials

(71) Applicant: VIETTEL GROUP, Ha Noi City (VN)

(72) Inventors: KY NAM PHAM, Ha Noi City (VN); TIEN DAT VU, Ha Noi City (VN); CONG HOANG PHUONG NGHIEM, Hai Duong City (VN); TRUONG VIET ANH NGUYEN, Trieu Son District (VN)

(73) Assignee: VIETTEL GROUP, Ha Noi City (VN)

(21) Appl. No.: 19/008,206

(22) Filed: Jan. 2, 2025

(30) Foreign Application Priority Data
Jan. 23, 2024 (VN) 1-2024-00546

(51) Int. Cl. B29C 70/34; B29C 70/86

(52) U.S. Cl. CPC B29C 70/347; B29C 70/342; B29C 70/865

(57) ABSTRACT

The invention outlines a method for producing large-sized square tubes from composite materials, incorporating a finishing process. This method addresses the need for high-quality square tube products made from composite materials, which must meet stringent requirements for lightweight design, high mechanical strength, and pressure resistance both internally and externally. The process consists of the following steps: step 1: prepare necessary equipment and materials; step 2: wind the inner layers; step 3: wrap the foam core layer over the inner layers; step 4: vacuum press the foam core layer onto the inner layers; step 5: wind the outer layers; step 6: vacuum press and heat to solidify the entire product; step 7: demould and finish the product.

### FIELD OF THE INVENTION

The invention is directed to a method for manufacturing pressure-resistant square tubes from composite materials. More specifically, the invention is implemented in the method of manufacturing of large-sized square tubes that can withstand internal or external pressure by using filament winding technique combined with sandwich structure in the industrial field.

### BACKGROUND DESCRIPTION

Compared to metal materials, composite materials offer superior mechanical properties, including light weight and a high strength-to-weight ratio. As a result, composite materials are increasingly used across various fields, ranging from civil applications to high-tech industries like aerospace. In the aerospace sector, products must meet strict requirements for low weight while ensuring durability under harsh operating conditions, such as exposure to loads, pressure, vibration, and temperature. These aerospace products often feature a tube structure with equipment and components housed inside. Currently, there are several methods available for manufacturing tube-shaped parts from composite materials, such as:
Hand lay-up method: this method offers the advantage of being low cost; however, it also has several disadvantages. These include a manual process, low product quality due to inadequate compaction between layers, a high volume of air bubbles and voids, and uneven thickness. Additionally, because the standard width of reinforcement fabric typically ranges from 1000 to 1500 mm, manufacturing large pipe products requires cutting and joining the fabric at multiple locations. This can lead to discontinuities in the composite material's structure, which negatively impacts the product's mechanical properties.
Resin infusion method: this method produces good product quality and can be semi-automated during the fabric wrapping stage. However, the resin infusion method has some disadvantages. It is challenging to implement for parts with significant thickness or high compaction among fabric layers, as the resin may not fully penetrate all layers of the reinforced fabric. Additionally, wrapping can only be performed with 0°/90° knitted fabric, limiting the ability to customize fiber orientation. This restriction can prevent optimal composite structure performance.
Method of using pre-impregnated fabric or yarn (prepregs): pre-impregnated fabric and yarn are commonly used in automatic tape laying (ATL) and automatic fiber placement (AFP) technologies. One major advantage of these methods is the high product quality achieved through optimal control of the resin-to-fiber ratio. However, the primary disadvantage is the cost; pre-impregnated fabric and yarn tend to be significantly more expensive, often two to three times the price of conventional fabric and yarn. Additionally, their service life is relatively short, usually less than 12 months, even under ideal storage conditions. Both ATL and AFP technologies also require substantial investments in machinery and equipment. Due to these factors, pre-impregnated fabrics are often not prioritized in the industry, particularly when cost is the main consideration.
Pultrusion method: this method is used to manufacture tubular products with a constant cross-section, which can be round, oval, square, rectangular, and more. The tube casting method is highly automated and produces products with good quality, a high fiber/plastic ratio, and a moderate price, making it suitable for large-scale industrial production. However, the major drawback of this method is its inability to manufacture large-sized parts due to limitations in mold size.
Filament winding method: this manufacturing method is commonly used for producing pipe products and pressure vessels. Its advantages include suitability for a wide range of products, from small to large sizes, the ability to optimize the winding angle based on specific usage conditions, and high automation capabilities. Additionally, the initial investment costs for equipment and manufacturing materials are significantly lower compared to using prepregs in Automated Tape Laying (ATL) or Automated Fiber Placement (AFP). However, the application of this winding method to manufacture large square or rectangular tube-shaped components is still quite limited. This is primarily due to several technical challenges that arise during the manufacturing process, including the distribution of yarn tension along the tube, compaction between layers, yarn slippage, and issues with product thickness. Notably, popular filament winding software such as Cadfil and ComposiCAD do not currently include specific functions for winding square or rectangular cross-section tubes.

When considering the structure of composite materials, pipes and pressure vessels typically require a significant thickness to ensure durability and prevent instability. However, increasing the thickness also leads to a greater mass due to the larger quantities of materials used, such as fibers and resin. This added mass can result in higher costs and can increase the loads on the supporting system or transportation means.

To solve the disadvantages mentioned earlier, the group of inventors has researched, tested and proposed a method for manufacturing large-sized pressure-resistant industrial tubes from composite materials by using the composite manufacturing method: filament winding. The selection and control of manufacturing parameters such as fiber tension, winding speed, mold design to control fiber slippage, number of fiber strips, and winding angle are carefully evaluated. To enhance the thickness of the tubes without significantly increasing their weight and while maintaining durability, a sandwich structure is employed.

### BACKGROUND OF THE INVENTION

The purpose of the invention is to propose a method of manufacturing large-sized square-section tubes with sandwich structures. This method aims to support the industrial production of composite material products that meet high standards for durability, pressure resistance, and lightweight properties. To achieve this objective, the manufacturing method involves the following steps: step 1: prepare necessary equipment and materials; step 2: wind the inner layers; step 3: wrap the foam core layer over the inner layers; step 4: vacuum press the foam core layer onto the inner layers; step 5: wind the outer layers; step 6: vacuum press and heat to solidify the entire product; step 7: remove the mold and finish the product.

### BRIEF DESCRIPTION OF THE DRAWINGS

Illustrations of the invention are described with reference to figures attached hereto identical structures, elements or parts that appear in more than one figure are generally labeled with the same numeral in all the figures in which they appear. Dimensions of components and features shown in the figures are not necessarily shown to scale.

FIG. 1 Schematic diagram illustrating the steps of the method.

FIG. 2 Schematic drawing illustrating the winding system.

FIG. 3 Schematic drawing illustrating the winding die design.

FIG. 4 Schematic drawing illustrating the material structure of the pipe product.

### DETAILED DESCRIPTION OF THE INVENTION

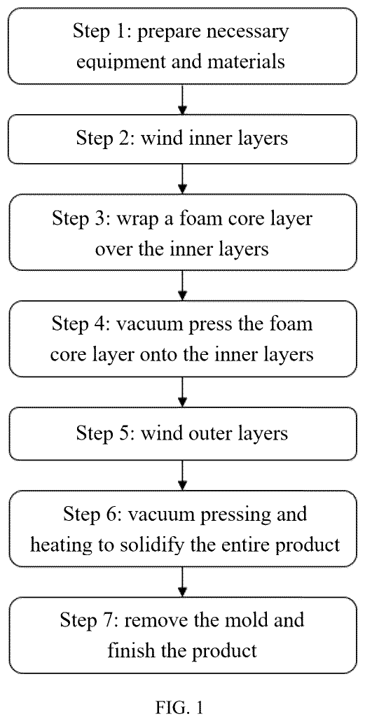

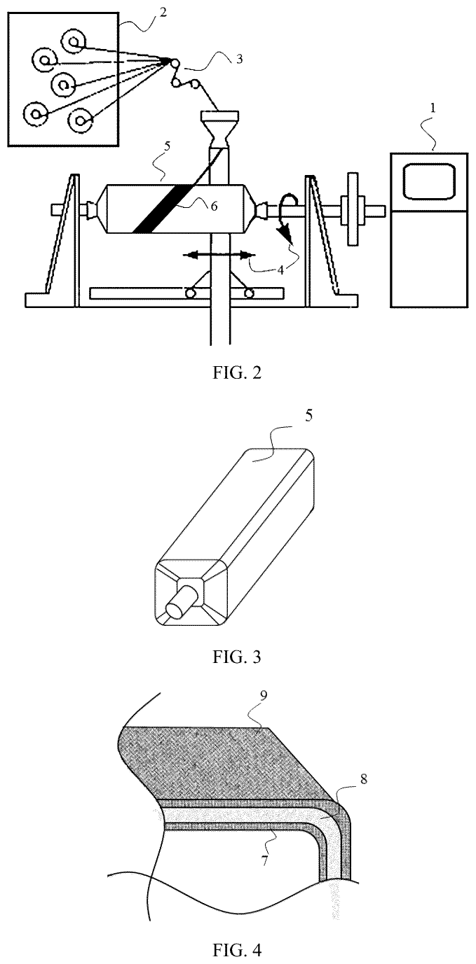

The manufacture of products using composite materials is regarded as advantageous for several reasons, including product quality, cost-effectiveness, and scalability. Product quality encompasses the quality of the composite materials themselves, the durability of the product's structure, and the extent to which the product meets user requirements. Quality in composite materials can be evaluated based on parameters such as void content and the fiber-to-plastic ratio. These parameters, along with the material structure (whether solid or sandwich) and geometric dimensions, significantly influence the product's durability and load-bearing capacity in operational conditions. Additionally, an appropriate composite material structure can help optimize the product's weight. Another critical factor is the geometric shape of the product, which should align closely with user requirements. As illustrated in FIG. 1, the process for manufacturing large-size square tubes from composite materials consists of several key steps:
Step 1: prepare necessary equipment and materials;
Step 2: wind inner layers;
Step 3: wrap a foam core layer over the inner layers;
Step 4: vacuum press the foam core layer onto the inner layers;
Step 5: wind outer layers;
Step 6: vacuum press and heat to solidify the entire product;
Step 7: remove the mold and complete the product.
According to the proposed invention, the steps to implement the method are as follows:
Step 1: prepare necessary equipment and materials;
Referring to FIGS. 1 and 2, the preparation process necessitates comprehensive readiness in terms of equipment and materials. Specifically, the required manufacturing materials include a base material (epoxy resin), reinforcing fibers (such as carbon fiber, Kevlar fiber, or glass fiber), and a foam core (such as PVC, PET, or SAN). In terms of equipment, a four-axis fiber winding system is essential. This system comprises several main components: control computer 1, fiber feed rack 2, fiber tension device 3, transmission shafts 4. Additionally, a hard mold, made from materials that do not react with the substrate (such as metal, steel, or aluminum, and wood), is required. The hard mold set includes several key features: the mold surface is designed as a square tube with a closed surface to facilitate vacuum pressing. The two ends of the mold are engineered to minimize fiber slippage and ensure that the fiber winding angle adheres to the design specifications. The mold also has a shaft for mounting on the winding machine. Furthermore, necessary equipment includes a vacuum pump and infrared heating lamps positioned along the mold. Other auxiliary equipment comprises scales, plastic containers, plastic pipes, shut-off valves, and vacuum gauges.
Step 2: wind inner layers;
The bundle of unidirectional fibers 6 is wound onto the rigid die 5 using the fiber winding device, adhering to the calculated angle and number of layers to ensure the product meets load requirements and maintains stable operating conditions. The rotation speed of the rigid die 5 is set to a low level, not exceeding 7 rpm. The actual width of the fiber bundle must be determined through a trial winding process before commencing product winding. Fiber tension is directly related to the pressure the fibers exert on the die, which in turn affects the compaction between layers. High fiber tension increases the fiber/resin ratio in the final product. However, for larger square tubes, there can be a sudden change in fiber tension at the edges and surface of the die, leading to potential fiber breakage when tension is too high. To manage this, the fiber tension generating device (3) is set to a maximum of 8N. Additionally, to minimize uneven fiber tension on the die, especially between the edges and the face of the tube, a roller-type device is employed.
Step 3: wrap a foam core layer over the inner layers;
After completing the wrapping of the inner shell layer 7, proceed to wrap the foam core layer 8. To ensure a successful implementation process, the foam core layer 8 must be pre-formed to match the contours of the rigid mold 5. Additionally, the foam core layer 8 should undergo surface treatment by creating resin injection holes, which will enhance the bond with the inner layers 7.
Step 4: vacuum press the foam core layer onto the inner layers;
After wrapping the foam core layer 8, both the inner layers 7 and the foam core layer need to be placed in a vacuum bag and vacuum pressed. This process enhances the compaction between the two layers, as well as among the fabric layers of the inner shell. Additionally, it helps reduce the void ratio and excess resin, thereby increasing the fiber ratio in the material structure. Vacuum pressing should be done for about 10 minutes. Once this step is completed, the entire mold system should be kept in this state for approximately 24 hours to allow the resin to solidify before proceeding to the next step.
Step 5: wind outer layers;
After wrapping the foam core layer 8 in step 4, proceed to wrap the outer layers 9 with reinforcing fibers, following the determined fiber direction and number of layers from the previous design stage.
Step 6: vacuum pressing and heating to solidify the entire product;
Vacuum press the entire product onto the mold. Similar to step 4, the purpose of vacuum pressing is to enhance the compaction between the material layers and minimize excess resin from the product. Once the vacuum pressing is complete, apply heat to the product. Rotate the mold evenly under the infrared heating lamp until the resin is completely solidified.
Step 7: remove the mold and finish the product;
Once the resin is fully cured, turn off the mold and infrared lamp. Allow the product to cool to room temperature before removing it from the mold.

### Impact of the Invention

The method described in this invention for manufacturing large square tubes from composite materials enables the production of high-quality tubes with square or rectangular cross-sections. Key factors such as mold design, rotation speed of the mold, fiber bundle width, and fiber tension are carefully evaluated and selected. This helps prevent fiber slippage, which can impact the initial optimal fiber orientation design and lead to issues with fiber separation, resulting in local voids. The vacuum pressing process enhances compaction between the material layers, thereby increasing the fiber-to-resin ratio and reducing the air void content in the final product. The lightweight design, made possible by a sandwich structure, ensures durability under operational loads. This method is also highly economical. The use of a sandwich structure significantly lowers material costs, as foam cores are much cheaper than reinforced fibers, particularly carbon fibers. Additionally, employing foam cores allows for a reduction in manufacturing material volume, decreases the operating time of the winding system, and ultimately saves on electricity, machine depreciation, and labor costs.

The method described in this invention is highly automated, with most of the winding of materials onto the mold completed by machine. This automation ensures high and consistent product quality while also reducing manufacturing time, which enhances the productivity of the production unit. The invention is detailed through a series of clearly outlined implementation steps. However, it should be noted that the invention is not limited to the specific embodiment presented. A person skilled in the art may implement the invention in various modified or altered ways without exceeding the scope defined by the protection claims. Consequently, the descriptions provided are for illustrative purposes only and do not impose any restrictions on the invention itself.

What is claimed is:

1. A method of manufacturing square tubes from composite materials includes the following steps:
Step 1: Prepare necessary equipment and materials;
the preparation process requires thorough organization of both equipment and materials, specifically, for manufacturing materials, required are base materials (epoxy resin), reinforcing fibers (carbon fiber, kevlar fiber, glass fiber, . . . ), foam cores (PVC, PET, SAN, . . . ); for equipment, the following are necessary: four-axis fiber winding system (including main components of control computer, fiber feed rack, fiber tension device, transmission shafts), additionally, a hard mold, made from materials that do not react with a substrate (such as metal, steel, or aluminum, and wood), is required, the hard mold includes several key features: a mold surface is designed as a square tube with a closed surface to facilitate vacuum pressing, a first and a second ends of the mold are engineered to minimize fiber slippage and ensure that a fiber winding angle adheres to a design specifications, the mold also has a shaft for mounting on a winding machine, furthermore, necessary equipment includes a vacuum pump and infrared heating lamps positioned along the mold, other auxiliary equipment comprises scales, plastic containers, plastic pipes, shut-off valves, and vacuum gauges;
Step 2: wind inner layers;
a bundle of unidirectional fibers is wound onto a rigid die using a fiber winding device, adhering to a calculated angle and number of layers to ensure the product meets load requirements and maintains stable operating conditions, a rotation speed of the rigid die is set to a low level, not exceeding 7 rpm, an actual width of the fiber bundle must be determined through a trial winding process before commencing product winding, a fiber tension generating device is set to a maximum of 8N, additionally, to minimize uneven fiber tension on the die, especially between edges and a face of the square tube, a roller-type device is employed;
Step 3: wrap a foam core layer over the inner layers;
once the inner shell is wrapped, move on to wrapping the foam core layer, for ease of implementation, the foam core layer should be pre-formed to match contours of the rigid mold, additionally, it is important to treat a surface of the foam core layer by creating plastic conduction holes, this will enhance its adhesion to the inner layers;
Step 4: Vacuum press the foam core layer onto the inner layers;
after wrapping the foam core layer, both the inner layers and the foam core layer should be placed in a vacuum bag and vacuum pressed, this process increases compaction between the two layers and within the fabric layers of the inner shell, helping to reduce a void ratio and excess resin while increasing a fiber ratio in the material structure, vacuum pressing should be performed for approximately 10 minutes, after this step, the entire mold system should be left in a same state for about 24 hours to allow the resin to solidify before proceeding to the next step;
Step 5: wind outer layers;
after completing the foam core wrapping in step 4, proceed to wrap the outer layers with reinforcing fibers, following a specified fiber direction and a number of layers established in the previous design stage;
Step 6: vacuum pressing and heating to solidify the entire product;
vacuum press the entire product onto the mold, this step is similar to step 4, where a goal is to enhance the compaction between the material layers and minimize the excess resin in the product, after the vacuum pressing is complete, heat the product, rotate the mold evenly under an infrared heating lamp until the resin is fully solidified;
Step 7: remove the mold and finish the product;
once the base resin has fully cured, turn off the mold and infrared lamp, allow the product to cool to room temperature before removing it from the mold.
